(19) United States
(12) Patent Application Publication
(10) Pub. No.: US 2025/0038297 A1
(43) Pub. Date: Jan. 30, 2025

(54) TRACTION BATTERY PACK THERMAL BARRIER AND METHOD OF ASSEMBLING TRACTION BATTERY PACK THERMAL BARRIER

(71) Applicant: Ford Global Technologies, LLC, Dearborn, MI (US)

(72) Inventor: Xiaogang Zhang, Novi, MI (US)

(21) Appl. No.: 18/357,623

(22) Filed: Jul. 24, 2023

(51) Int. Cl. H01M 10/653; B60L 50/64; H01M 10/04; H01M 50/204; H01M 50/289

(52) U.S. Cl. CPC H01M 10/653; B60L 50/64; H01M 10/0481; H01M 50/204; H01M 50/289; H01M 2220/20

(57) ABSTRACT

A traction battery pack thermal barrier assembly includes a first outer shell; a second outer shell adjacent the first outer shell to define an insulation cavity; and an insulative material sandwiched between the first outer shell and the second outer shell within the insulation cavity. Baffles extend into the insulation cavity and restrict movement of the insulative material within the insulation cavity.

### TECHNICAL FIELD

This disclosure relates generally to a thermal barrier used in a traction battery pack.

### BACKGROUND

A traction battery pack of an electrified vehicle can include groups of battery cells arranged in one or more cell stacks. Thermal barriers can be incorporated into the traction battery pack to help manage thermal energy.

### SUMMARY

In some aspects, the techniques described herein relate to a traction battery pack thermal barrier assembly, including: a first outer shell; a second outer shell adjacent the first outer shell to define an insulation cavity; an insulative material sandwiched between the first outer shell and the second outer shell within the insulation cavity; and a plurality of baffles that extend into the insulation cavity and restrict movement of the insulative material within the insulation cavity.

In some aspects, the techniques described herein relate to a traction battery pack thermal barrier assembly, wherein the first outer shell, the second outer shell, and the insulative material provide a thermal barrier assembly configured to separate a first group of battery cells within a cell stack from a second group of battery cells within the cell stack.

In some aspects, the techniques described herein relate to a traction battery pack thermal barrier assembly, wherein the plurality of baffles includes plurality of ribs of the first outer shell, a plurality of ribs of the second outer shell, or both.

In some aspects, the techniques described herein relate to a traction battery pack thermal barrier assembly, wherein the plurality of baffles includes a plurality of first ribs extending from an underside of the first outer shell, and a plurality of second ribs extending from an underside of the second outer shell, the plurality of first ribs contacting the plurality of second ribs to provide a plurality of aerogel containing compartments.

In some aspects, the techniques described herein relate to a traction battery pack thermal barrier assembly, further including a first outer rim of the first outer shell and a second outer rim of the second outer shell, the first outer rim overlapping with the second outer rim.

In some aspects, the techniques described herein relate to a traction battery pack thermal barrier assembly, wherein the first outer rim extends at least partially about a circumferential periphery of the first outer shell, wherein the second outer rim extends at least partially about a circumferential periphery of the second outer shell.

In some aspects, the techniques described herein relate to a traction battery pack thermal barrier assembly, wherein the first outer rim overlaps with the second outer rim along three peripheral sides of the first outer rim.

In some aspects, the techniques described herein relate to a traction battery pack thermal barrier assembly, wherein the insulative material is a particulate substance.

In some aspects, the techniques described herein relate to a traction battery pack thermal barrier assembly, wherein the insulative material is an aerogel.

In some aspects, the techniques described herein relate to a traction battery pack thermal barrier assembly, wherein the insulative material is fiberless.

In some aspects, the techniques described herein relate to a traction battery pack thermal barrier assembly, wherein the first outer shell and the second outer shell are polymer-based materials.

In some aspects, the techniques described herein relate to a method of assembling a thermal barrier of a traction battery pack, including: placing a first outer shell adjacent to a second outer shell; introducing an insulative material into an insulation cavity between the first outer shell and the second outer shell; influencing distribution of the insulative material within the insulation cavity using a plurality of baffles; and compressing the insulative material between the first outer shell and the second outer shell to contain the insulative material within the insulation cavity.

In some aspects, the techniques described herein relate to a method, further including compartmentalizing the insulation cavity using the plurality of baffles.

In some aspects, the techniques described herein relate to a method, further including contacting a first plurality of ribs of the first outer shell against the second outer shell when compartmentalizing the insulation cavity.

In some aspects, the techniques described herein relate to a method, further including contacting the first plurality of ribs against a second plurality of ribs of the second outer shell when compartmentalizing the insulation cavity.

In some aspects, the techniques described herein relate to a method, further including, during the compressing, overlapping a first outer rim of the first outer shell with a second outer rim of the second outer shell.

In some aspects, the techniques described herein relate to a method, further including, during the compressing, communicating air out of the insulation cavity.

In some aspects, the techniques described herein relate to a method, further including injecting the insulative material into the insulation cavity during the introducing.

In some aspects, the techniques described herein relate to a method, further including placing the thermal barrier within a cell stack between a first group of battery cells and a second group of battery cells.

In some aspects, the techniques described herein relate to a method, further including compartmentalizing a portion of a traction battery pack using the thermal barrier.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle.

FIG. 2 illustrates an expanded, perspective view of a battery pack from the electrified vehicle of FIG. 1 and schematically showing cell stacks of the battery pack.

FIG. 3 illustrates a section view taken at line 3-3 in FIG. 2.

FIGS. 4 to 4B illustrates various view of a thermal barrier from the battery pack of FIG. 2.

FIG. 5 illustrates a first outer shell and a second outer shell from a thermal barrier of the battery pack of FIG. 2.

FIGS. 6 to 6B illustrates various view of the first outer shell and the second outer shell being filled with an insulative material to provide the thermal barrier.

### DETAILED DESCRIPTION

This disclosure details exemplary thermal barriers for a traction battery pack, and methods of manufacturing those thermal barrier.

The thermal barriers can include an insulative material, such as aerogel. The thermal barriers can include support features that facilitate an even distribution of the insulative material throughout the thermal barrier. In exemplary embodiments, these support features are part of a shell or housing for the thermal barrier.

The thermal barriers can, in some examples, compartmentalize areas of a traction battery pack and help to contain and direct gas and debris vented from one or more battery cells during a thermal event. Guiding the gas and debris away from other battery cells—other battery cells that are not venting—can help to prevent the thermal event from cascading to those other battery cells.

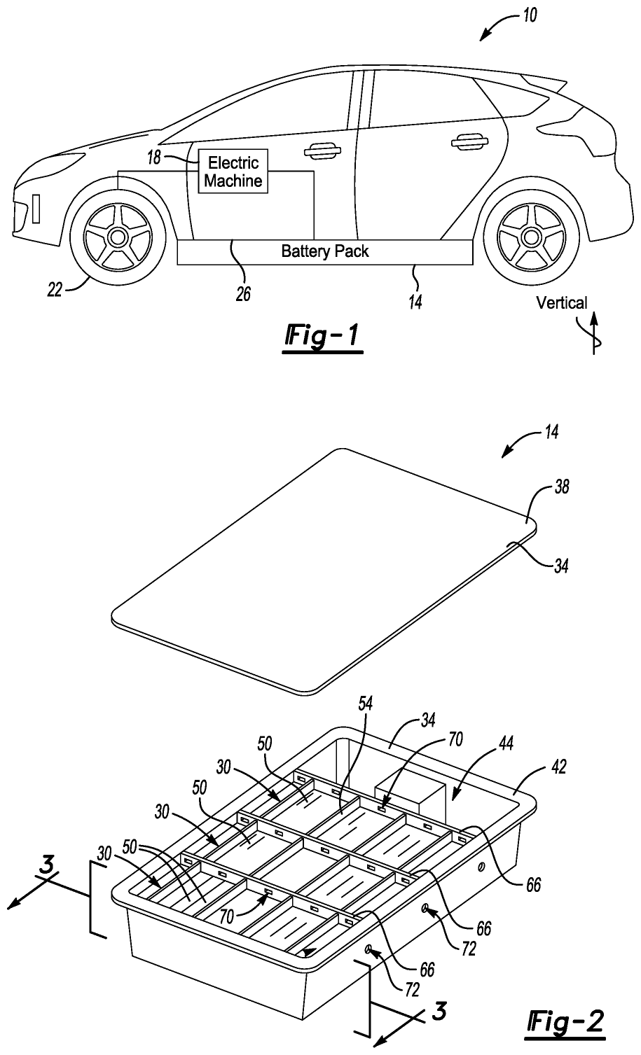

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

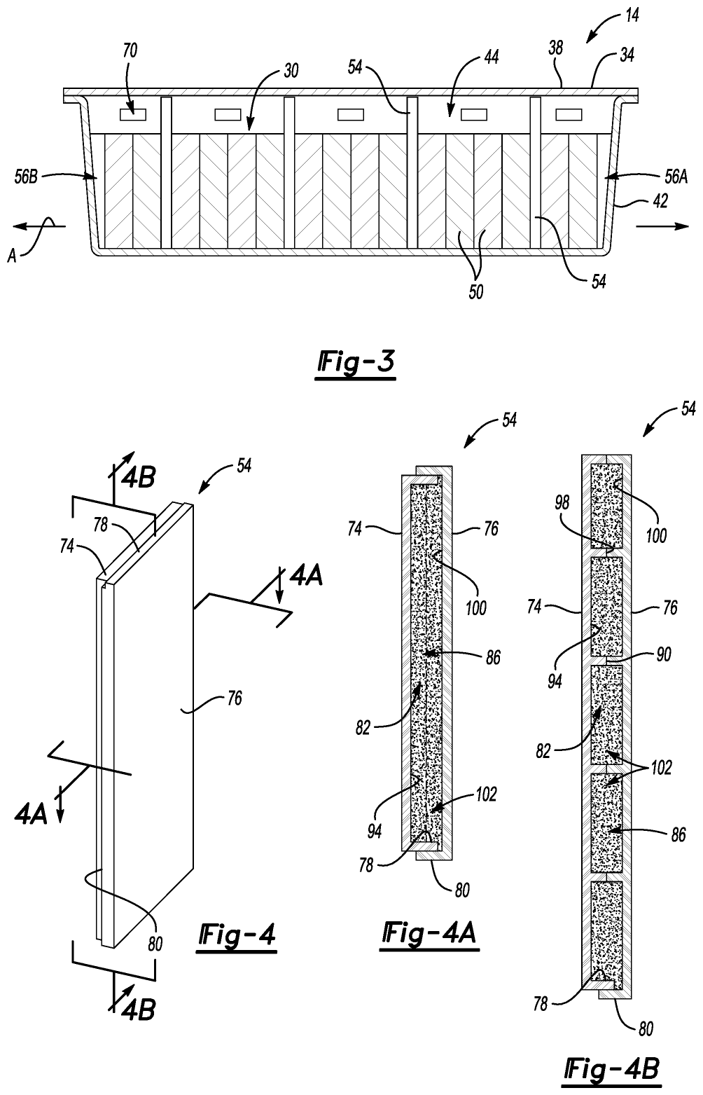

With reference now to FIGS. 2 and 3, the battery pack 14 includes a plurality of cell stacks 30 held within a battery pack enclosure 34. In the exemplary embodiment, the enclosure 34 includes an enclosure cover 38 and an enclosure tray 42. The enclosure cover 38 is secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply, “cells”) and at least one thermal barrier 54 disposed along a respective cell stack axis A. The cell stacks 30 each extend from a first axial end 56A to an opposite, second axial end 56B.

Within each cell stack 30, the battery cells 50 are stacked side-by-side relative to each other along the cell stack axis A. Within each cell stack 30, the thermal barriers 54 separate groups of the battery cells 50 from other groups of the battery cells 50. The groups of battery cells 50 can include one or more battery cells 50.

The battery cells 50 store and supply electrical power. Although specific numbers of the cell stacks 30 and cells 50 are illustrated in the various figures of this disclosure, the battery pack 14 could include any number of the cell stacks 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

The example battery cells 50 can include a tab terminals extending from a housing. An aluminum film can provide the housing, for example.

From time to time, pressure and thermal energy within one or more of the battery cells 50 can increase. The pressure and thermal energy increase can be due to an overcharge condition, for example. The pressure and thermal energy increase can cause the associated battery cell 50 to rupture and release gas and debris.

The gases and debris can be released from the associated battery cell 50 through a designated vent within the housing, such as a membrane that yields in response to increased pressure, or through a ruptured area of the associated battery cell 50. If a designated vent, the vent could be positioned to direct a flow of vented gas and debris away from terminals of the battery cells 50.

The example battery pack 14 includes cross-member assemblies 66 disposed between cell stacks 30. The example cross-member assemblies 66 extend longitudinally in a direction that is parallel to the cell stack axes A. The cross-member assemblies 66 and the cell stack axes A extend in a cross-vehicle direction (i.e., from a driver side to a passenger side).

The thermal barriers 54 extend outward from the axis A past the cells 50 to contact the cross-member assemblies 66 and or the battery pack enclosure 34. This can compartmentalize groups of the battery cells 50. When one or more of the battery cells 50 within a group vent, the vent byproducts V are directed through openings 70 within the cross-members assemblies 66. The vent byproducts V thus flow into the cross-member assemblies 66 rather than flowing axially to positions adjacent to other groups of battery cells 50 in the cell stack 30. From the cross-member assemblies 66, the vent byproducts can be expelled from the battery pack 14 through an enclosure vent 72.

Vent byproducts V flowing adjacent to other battery cells 50 can increase thermal energy levels in those battery cells 50 and lead to a cascading thermal event. Redirecting thermal energy outward from the axis A can help to prevent the thermal energy moving to other groups of the battery cells 50 and the thermal event from cascading to other groups of battery cells 50 that are not venting.

In this example, the thermal barriers 54 separate groups of four battery cells 50 within a given one of the cell stacks 30 from other groups of battery cells 50 within that cell stack 30. Thus, vent products V from a venting battery cell 50 flow adjacent to, at most, other battery cells 50 within that group before moving through the openings 70 rather than other groups of the battery cells 50.

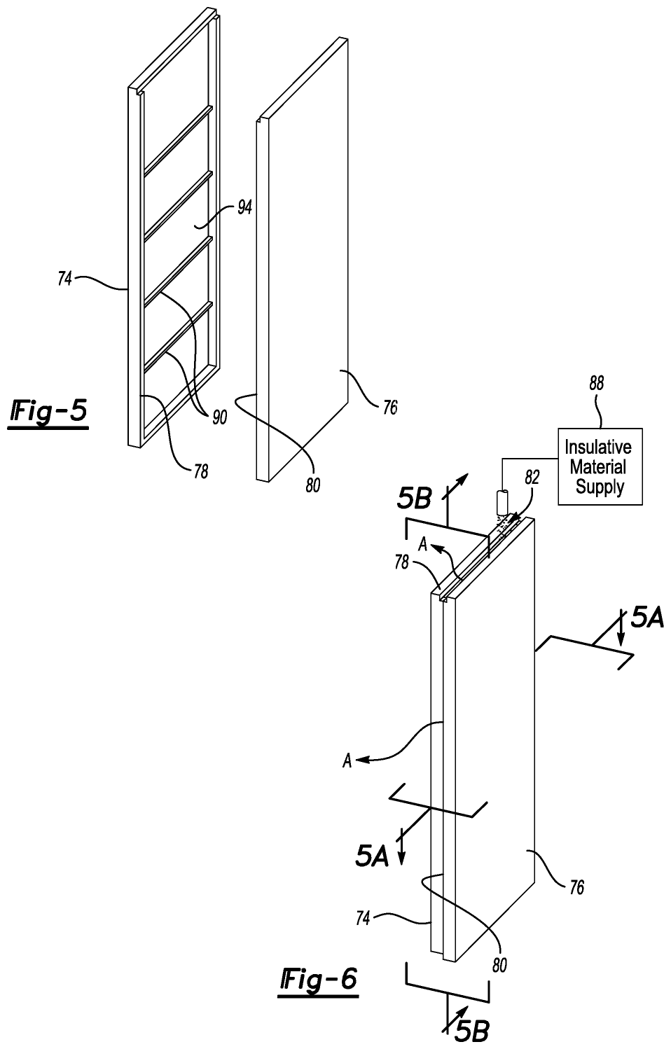

With reference now to FIGS. 4 to 5 and continuing reference to FIGS. 2 and 3, the thermal barriers 54 each includes a first outer shell 74, a second outer shell 76, and an insulative material 82 that is sandwiched between the first outer shell 74 and the second outer shell 76. The first outer shell 74 includes a first shell outer rim 78 extending at least partially about a circumferential periphery of the first outer shell 74. The second outer shell 76 includes a second shell outer rim 80 extending at least partially about a circumferential periphery of the second outer shell 76.

The first outer shell 74 and the second outer shell 76 are polymer-based materials in this example. The first outer shell 74 and the second outer shell 76 could be other types of materials in other examples.

The first outer shell 74 and the second outer shell 76 are positioned adjacent to each other to define an insulation cavity 86 that holds the insulative material 82. Notably, the example first shell outer rim 78 includes portions that overlap with portions of the second shell outer rim 80. In this example, the first shell outer rim 78 overlaps with the second shell outer rim 80 along three peripheral sides of the thermal barrier 54. Along the remaining fourth peripheral side, the first shell outer rim 78 abuts the second shell outer rim 80.

In this example, the first outer shell 74 includes a plurality of first baffles 90 extending from a underside 94 of the first outer shell 74 into the insulation cavity 86. Further, the second outer shell 76 includes a plurality of second baffles 98 extending into the insulation cavity 86 from a underside 100 of the second outer shell 76.

The example first baffles 90 are ribs that span the width of the thermal barrier 54 from the first shell outer rim 78 on one side of the thermal barrier 54 to the first shell outer rim 78 on the opposing side. The example second baffles 98 similarly span the second outer shell 76. In other examples, the first baffles 90, the second baffles 98, or both could be pins instead of ribs, or could extend only partially across the thermal barrier 54. The ribs providing the first baffles 90 and the second baffles 98 can have a rectangular cross-section and can, for example, be one millimeter thick and project about two millimeters from the respective underside 94 or 100.

For the portions of the first shell outer rim 78 that overlap with portions of the second shell outer rim 80, the portions can extend from the underside 94 about three millimeters and can be about one millimeter thick.

The first outer shell 74 can be narrower and shorter than the second outer shell 76 to allow the first shell outer rim 78 to nest and overlap with the second shell outer rim 80 along the three sides of the thermal barrier 54.

The insulative material 82, in this example, is an aerogel powder. The insulative material is thus provided by a particulate substance. The insulative material could be other materials in other examples, including other particulate substances.

As can be appreciated, an even distribution of the insulative material 82 within insulation cavity 86 of the thermal barrier 54 is desirable. This can help to ensure that the thermal barrier 54 adequately blocks thermal energy along an entirety of the thermal barrier 54. As the vehicle 10 is driven, vibration can tend to cause the insulative material 82 to gradually move and collect at a vertical bottom of the thermal barrier 54 leading to an uneven distribution of the insulative material. In the past, a glass fiber mat has been incorporated into thermal barriers to thwart movement of the insulative material within a thermal barrier. The glass fiber mat, among other things, adds to the complexity of the thermal barrier.

The example thermal barrier 54 can help to hold the position of the insulative material 82 without relying on a glass fiber mat. In the example thermal barrier 54, the first baffles 90 contact the second baffles 98 to subdivide the insulation cavity 86 into a plurality of subcavities 102. Subdividing the insulation cavity 86 in this way can help to restrict movement of the insulative material 82 within the insulation cavity 86. An amount to the insulative material 82 is held within each of the subcavities 102 and blocked from migrating to other subcavities 102.

While the example subcavities 102 are established using both the first baffles 90 from the first outer shell 74 and the second baffles 98 from the second outer shell 76, other examples could only use the first baffles 90 to establish the subcavities 102 or only the second baffles 98 to establish the subcavities 102. That is, the second baffles 98 could be omitted and the first baffles 90 could extend all the way from the underside 94 of the first outer shell 74 to the underside of the second outer shell 76. Correspondingly, the first baffles 90 could be omitted and the second baffles 98 could extend all the way from the underside 94 of the first outer shell 74 to the underside of the second shell outer rim 80.

The example first baffles 90 extend perpendicularly from the underside 94 into the insulation cavity 86, and the example second baffles 98 extend perpendicularly from the underside 100 into the insulation cavity 86. In another example, the first baffles 90, the second baffles 98, or both, could extend non-perpendicularly from the respective underside 94 of the underside 100. For example, the first baffles 90 could extend at a forty-five degree angle from the underside 94.

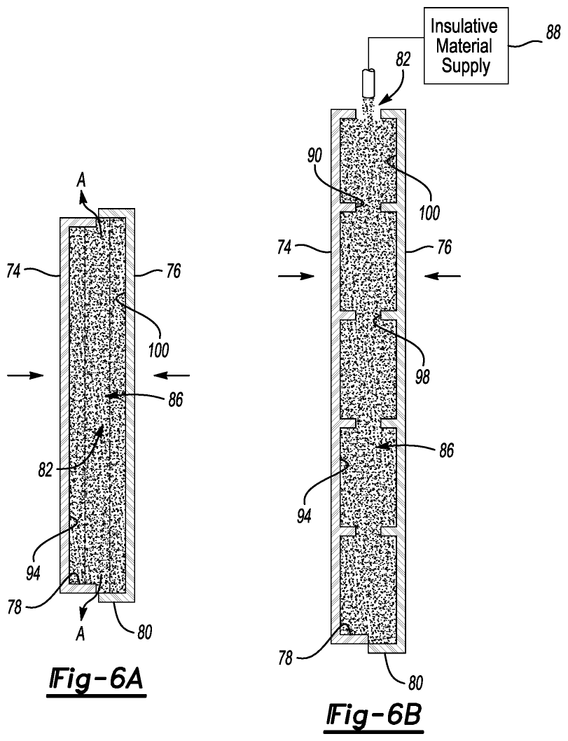

A method of assembling the thermal barrier 54 can include the step of placing the first outer shell 74 and the second outer shell 76 adjacent to each other to provide the insulation cavity 86 as shown in FIGS. 6 to 6B. At this point, the first baffles 90 are not directly contacting the second baffles 98. Next, the insulative material 82 is introduced into the insulation cavity 86. The insulative material 82 can be introduced via an injection process that draws the insulative material from an insulative material supply 88.

Some of the insulative material 82 is caught supported by the first baffles 90 and the second baffles 98 as the insulative material 82 is introduced. The first baffles 90 and the second baffles 98 thus prevent all the insulative material 82 from collecting at a vertical bottom of the insulation cavity.

Next, the first outer shell 74 and the second outer shell 76 are compressed against one another. Air A is forced out from within the insulation cavity 86 as the insulative material 82 is compressed when the first outer shell 74 and the second outer shell 76 are compressed against each other. The first outer shell 74 and the second outer shell 76 are compressed against one another until the first baffles 90 contact the second baffles 98 as shown in FIGS. 4 to 4B. After such contact, the insulation cavity 86 is divided into subcavities 102. Once the first baffles 90 are in contact with the second baffles 98, the insulative material 82 is contained within one of the subcavities 102.

The first outer shell 74 and the second outer shell 76 are then secured together using heat stakes, fasteners, adhesives, etc. The thermal barrier 54 can then be reoriented and positioned within one of the cell stacks 30 between a first group of battery cells 50 and a second group of battery cells 50 as shown in FIGS. 2 to 3.

Features of this disclosure include a thermal barrier having a fiberless construction, which can reduce complexity.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack thermal barrier assembly, comprising:
a first outer shell;
a second outer shell adjacent the first outer shell to define an insulation cavity;
an insulative material sandwiched between the first outer shell and the second outer shell within the insulation cavity; and
a plurality of baffles that extend into the insulation cavity and restrict movement of the insulative material within the insulation cavity.

2. The traction battery pack thermal barrier assembly of claim 1, wherein the first outer shell, the second outer shell, and the insulative material provide a thermal barrier assembly configured to separate a first group of battery cells within a cell stack from a second group of battery cells within the cell stack.

3. The traction battery pack thermal barrier assembly of claim 1, wherein the plurality of baffles comprises plurality of ribs of the first outer shell, a plurality of ribs of the second outer shell, or both.

4. The traction battery pack thermal barrier assembly of claim 1, wherein the plurality of baffles comprises a plurality of first ribs extending from an underside of the first outer shell, and a plurality of second ribs extending from an underside of the second outer shell, the plurality of first ribs contacting the plurality of second ribs to provide a plurality of subcavities.

5. The traction battery pack thermal barrier assembly of claim 1, further comprising a first outer rim of the first outer shell and a second outer rim of the second outer shell, the first outer rim overlapping with the second outer rim.

6. The traction battery pack thermal barrier assembly of claim 5, wherein the first outer rim extends at least partially about a circumferential periphery of the first outer shell, wherein the second outer rim extends at least partially about a circumferential periphery of the second outer shell.

7. The traction battery pack thermal barrier assembly of claim 5, wherein the first outer rim overlaps with the second outer rim along three peripheral sides of the first outer rim.

8. The traction battery pack thermal barrier assembly of claim 1, wherein the insulative material is a particulate substance.

9. The traction battery pack thermal barrier assembly of claim 1, wherein the insulative material is an aerogel.

10. The traction battery pack thermal barrier assembly of claim 1, wherein the insulative material is fiberless.

11. The traction battery pack thermal barrier assembly of claim 1, wherein the first outer shell and the second outer shell are polymer-based materials.

12. A method of assembling a thermal barrier of a traction battery pack, comprising:
placing a first outer shell adjacent to a second outer shell;
introducing an insulative material into an insulation cavity between the first outer shell and the second outer shell;
influencing distribution of the insulative material within the insulation cavity using a plurality of baffles; and
compressing the insulative material between the first outer shell and the second outer shell to contain the insulative material within the insulation cavity.

13. The method of claim 12, further comprising compartmentalizing the insulation cavity using the plurality of baffles.

14. The method of claim 13, further comprising contacting a first plurality of ribs of the first outer shell against the second outer shell when compartmentalizing the insulation cavity.

15. The method of claim 14, further comprising contacting the first plurality of ribs against a second plurality of ribs of the second outer shell when compartmentalizing the insulation cavity.

16. The method of claim 12, further comprising, during the compressing, overlapping a first outer rim of the first outer shell with a second outer rim of the second outer shell.

17. The method of claim 16, further comprising, during the compressing, communicating air out of the insulation cavity.

18. The method of claim 12, further comprising injecting the insulative material into the insulation cavity during the introducing.

19. The method of claim 12, further comprising placing the thermal barrier within a cell stack between a first group of battery cells and a second group of battery cells.

20. The method of claim 12, further comprising compartmentalizing a portion of a traction battery pack using the thermal barrier.
